(19) United States
(12) Patent Application Publication
(10) Pub. No.: US 2001/0042693 A1
(43) Pub. Date: Nov. 22, 2001

(54) Electrochemical sensor for detection and quantification of trace metal ions in water

(76) Inventors: Elina Onitskansky, Lyndhurst, OH (US); Meijun Shao, Richmond Heights, OH (US); Laurie Dudik, South Euclid, OH (US); Chung-Chiun Liu, Cleveland Heights, OH (US)

Correspondence Address: JOSEPH G CURATOLO, ESQ., RENNER KENNER GREIVE BOBAK TAYLOR & WEBER, 24500 CENTER RIDGE ROAD, SUITE 280, WESTLAKE, OH, 44145, US

(21) Appl. No.: 09/799,963

(22) Filed: Mar. 6, 2001

Related U.S. Application Data
(60) Provisional application No. 60/187,606, filed on Mar. 7, 2000.

(51) Int. Cl. G01N 27/333

(52) U.S. Cl. 205/780; 204/412

(57) ABSTRACT

A thick film electrochemical micro-sensor apparatus for detection and quantification of trace metal ions in water, comprising a substrate to which is applied an arrangement of electrodes comprising at least one of a first type of working electrode, at least one of a second type of working electrode, a counter electrode, a reference electrode, and optionally pH and temperature detectors. The apparatus is especially useful for detection and quantification of trace metal ions in water and effluent. A method of detecting and quantifying trace metal ions using the electrochemical micro-sensor apparatus is also described comprising contacting the water or effluent with the sensor of the present invention, applying a voltage selected for the trace metal ion to be detected, measuring the current output of the micro-sensor, determining if the current output indicates the presence of the trace metal ion, and generating a signal.

### CROSS REFERENCE TO RELATED APPLICATIONS

This application claims priority from U.S. Provisional Application 60/187,606, filed on Mar. 7, 2000.

### TECHNICAL FIELD

The present invention is directed to an electrochemical micro-sensor apparatus for detecting and quantifying trace metal ions in water, and optionally a plating means for removing the metals. More particularly, the invention is directed to a thick film electrochemical micro-sensor apparatus capable of in situ operation for detection and quantification of trace amounts of cadmium, copper, iron, lead, nickel, and zinc ions in water and effluent. The invention optionally includes a plating means for removing and recovering these metals from water and effluent.

### BACKGROUND OF THE INVENTION :

A wide range of human activities contributes to the trace element pollution of the aquatic environment. The major activities include mining and ore processing; coal and fuel combustion; industrial processing including chemical, metal, alloys, chloro-alkali, petroleum; agricultural including fertilizers, pesticides and herbicides, domestic and agricultural effluents or sewage, transportational including urban and motorway run-off; and, nuclear activity. Elemental or heavy metal input can occur from atmospheric fallout, leaching or dumping from the lithosphere, or directly into the aquatic environment, including ground, surface, river, lakes, estuarine, oceans, etc. Sources of six important soluble metal ions, cadmium, copper, iron, lead, nickel, and zinc, are summarized in Table 1.

TABLE 1

| | CAD- | COP- | | | NICK- | |
|---|---|---|---|---|---|---|
| ACTIVITY | MIUM | PER | IRON | LEAD | EL | ZINC |
| Mining and ore | X | X | X | X | X | X |
| processing | | | | | | |
| Coal and fuel | X | X | X | X | X | X |
| combustion | | | | | | |
| Industrial processing | X | X | X | X | X | X |
| Agricultural | X | X | | X | X | X |
| Domestic and | X | X | X | X | X | X |
| agricultural | | | | | | |
| effluent/sewage | | | | | | |
| Transport | X | X | | X | X | X |
| Nuclear industry | X | | | | | |

The impact of water pollution depends upon the magnitude of trace element input, duration of input, physical and chemical form, and associated ligands. All of these inter-related factors will determine the elemental concentrations in water systems, and their relative availability, transport, and toxicity. Typical natural trace metal ion concentrations of fresh water, river water, and sea water are shown in Table 2.

TABLE 2
TYPICAL NATURAL TRACE ELEMENT
CONCENTRATIONS OF FRESH WATER, RIVER
WATER, AND SEA WATER

| TRACE | CONCENTRATIONS (ppb) | | |
|---|---|---|---|
| ELEMENT | Fresh Water | River Water | Sea Water |
| Cadmium | 0.03 | 0.02 | 0.10 |
| Copper | 3.0 | 5.0 | 2.0 |
| Iron | 500.0 | 40.0 | 2.0 |
| Lead | 1.0 | 3.0 | 0.03 |
| Nickel | 0.5 | 0.3 | 0.5 |
| Zinc | 15 | 20 | 10 |

The most important factor in determining the impact of an element is the chemical form in which the element exists in solution. This depends on pH, solubility, temperature, the nature of other chemical species, and many basic factors of solution chemistry. The major chemical species of cadmium, copper, iron, lead, nickel, and zinc found in natural waters are shown in Table 3.

TABLE 3
MAJOR CHEMICAL SPECIES FOUND IN NATURAL WATERS

| TRACE | |
|---|---|
| METAL IONS | CHEMICAL SPECIES |
| Cadmium | CdCl⁺, CdCl₂, CdCl₃⁻, Cd²⁺ |
| Copper | Cu²⁺, Cu(OH)⁺, CUSO₄, CUCO₃ |
| Iron | [Fe(OH)₂]⁺, [Fe(OH)₄]⁻ |
| Lead | Pb²⁺, PbCO₃, PbCl⁺, PbCl₂, PbCl₃, Pb(OH)⁺, Pb(OH)₂, |
| | Pb(OH)₃⁻, Pb₃(OH)₄²⁺, Pb₄(OH)₄⁴⁺ |
| Nickel | Ni²⁺ |
| Zinc | Zn(OH)⁺, Zn(OH)₂, ZnCl⁺, ZnCl₂, ZnCO₃, Zn²⁺ |

Many trace metal ion contaminants entering the aquatic environment can have a dramatic effect on the bioavailability and toxicity of biological processes. In particular, bio-amplification by plankton, or bio-transformation by bacteria in the water-sediment interface can strongly influence elemental toxicity throughout the remaining food chain. For example, lead undergoes biomethylation in the water-sediment interface, resulting in the production of more toxic species which are concentrated in shellfish or fish. During the past 50 years, there has been a rapid increase in the number of major trace element-related water pollution incidents.

Examples include cadmium in the Jinstu River, Japan (traced to effluents from zinc mining) which produced Itai-Itai or severe bone damage disease in the local human population. An ever increasing problem is the effect of atmospheric pollution and acid rain on the aquatic environment. Relatively pure rain water has a pH of 5.5 but owing to SO₂ and NOₓ emissions, the pH of rain can drop as low as 2-3. This increases the acidity of lakes and accelerates the leaching of trace elements from soils, which in turn affects both the metabolism of soil organisms and aquatic life. An example of this process is the increase in aluminum in lake waters due to the increased mobilization from soils.

The source and potential harm of cadmium, copper, iron, lead, nickel, and zinc is discussed in greater detail below.

Cadmium is highly toxic and has been implicated in some cases of poisoning through food. Minute quantities of cadmium are suspected of being responsible for adverse changes in arteries of human kidneys. Cadmium also causes generalized cancers in laboratory animals and has been linked epidemiologically with certain human cancers. A cadmium concentration of 200 μg/L is toxic to certain fish.

Cadmium may enter water as a result of industrial discharges or the deterioration of galvanized pipe.

Copper salts are used in water supply systems to control biological growths in reservoirs and distribution pipes and to catalyze the oxidation of manganese. Corrosion of copper-containing alloys in pipe fittings may introduce measurable amounts of copper into the water in a pipe system.

In water samples, iron may occur in true solution, in a colloidal state that may be peptized by organic matter, in inorganic or organic iron complexes, or in relatively coarse suspended particles. It may be either ferrous or ferric, suspended or dissolved. Iron in water can cause staining of laundry and porcelain. A bittersweet astringent taste is detectable by some persons at levels above 1 mg/L.

Lead is a serious cumulative body poison. Natural waters seldom contain more than 5 μg/L, although much higher values have been reported. Lead in a water supply may come from industrial, mine, and smelter discharges, or from the dissolution of old lead plumbing. Tap waters that are soft, acid, and not suitably treated may contain lead resulting from an attack on lead service pipes or solder pipe joints.

Zinc is an essential and beneficial element in human growth. Concentrations above 5 mg/L can cause a bitter astringent taste and an opalescence in alkaline waters. Zinc most commonly enters the domestic water supply from deterioration of galvanized iron and dezincification of brass. In such cases lead and cadmium may also be present because they are impurities of the zinc used in galvanizing. Zinc in water may also result from industrial waste pollution.

Some compounds of nickel are highly toxic and may be carcinogenic. Potential symptoms of overexposure are sensitization dermititis, allergic asthma, pneumonitis. It is used in nickel-plating, as a catalyst for hydrogenation reactions, and in stainless steels, heat and corrosion resistant alloys, and in alloys for electronic and space applications.

For these reasons, it is important to be able to detect the presence of these metal ions, and to quantify the amount present quickly and accurately. Further, removal methods are necessary for instances when the amount of these trace metal ions is dangerously high.

Sampling of water requires careful procedures and can introduce potential errors in measurement. Because most trace metal ions to be measured are at very low levels, sample contamination and analyte losses are potential problems. Special precautions are necessary for samples containing trace metal ions. Because many constituents may be present at concentrations of micrograms per liter, they may be totally or partially lost if proper sampling and preservation procedures are not followed. Cadmium, copper, iron, lead, and zinc are subject to loss by adsorption on, or ion exchange with, container walls, or by precipitation.

Typical methods of analysis include atomic absorption spectroscopy, inductively coupled plasma emission spectroscopy, and colourometric methods. Water samples must be collected and transported to a lab, where they are then analyzed. Sample pretreatment including filtration and acid digestion is often necessary. This is time-consuming and further increases the chances of contamination and imprecision.

For these reasons, it would be advantageous to develop a method to detect and quantify cadmium, copper, iron, lead, nickel, and zinc ions in water and effluent samples that can be performed in situ, requiring no sample storage, transport, or pretreatment.

Electrochemical methods of analysis include all methods of analysis that measure current, potential and resistance, and relate them to analyte concentration. Voltammetric techniques have been classified as dynamic electrochemical techniques. They are based on the measurement of current as a function of potential. Voltammetry is an important quantitative tool. Typically, the voltammetric measurement is made in a cell filled with electrolyte in which three electrodes are immersed, the indicator (or working) electrode, the reference electrode, and the auxiliary (or counter) electrode. A potential waveform is applied to the working electrode with respect to the reference electrode. At some potential, a redox reaction will occur, the current is measured and plotted against potential. The potential at which the reaction occurs is characteristic of the analyte, based on the Gibbs free energy of the reactions, and the amount of current that is measured is related to concentration.

Amperometry is identical in theory to voltammetry, the only difference is that, whereas in a voltammetric experiment the applied potential is scanned, in amperometric experiments the current is measured at a fixed potential.

Portable electrochemical devices have been developed to measure substances such as carbon monoxide, sulfur dioxide, hydrogen disulphide, hydrogen cyanide, and glucose in fluid materials. U.S. Pat. No. 5,437,772, to DeCastro et al., describes an electrochemical sensor apparatus for detecting trace metals in which the electrodes are coated with mercury.

U.S. Pat. No. 5,676,820 to Wang et al. describes a sensor used to monitor metal contaminants in a remote location, connected via a communications cable to an analysis device.

The technology of thick film electrochemical micro-sensors has been used in various fields because it is cost efficient and can be easy to manufacture and use. They have been used to detect acidity in water and even for monitoring human health. However, being a relatively new technology, thick-film electrochemical micro-sensors have not yet been applied to multielement detection and quantification of trace metals in water and effluent.

It is therefore an object of the present invention to provide a thick film electrochemical micro-sensor for detecting trace amounts of at least one of cadmium, copper, iron, lead, nickel and zinc ions in water and effluent.

It is a further object of the present invention to optionally provide a means of plating trace amounts of at least one of soluble cadmium, copper, iron, lead, nickel, and zinc ions from water and effluents.

### SUMMARY OF THE INVENTION

The present invention provides an effective and economical electrochemical micro-sensor apparatus for detecting or quantifying trace metal ions comprising a substrate supporting an arrangement of electrodes comprising at least one of a first type of working electrode; at least one of a second type of working electrode; a reference electrode; and a counter electrode; wherein the electrodes are applied to the substrate using a thick film technique, and wherein each working electrode is sensitive to at least one metal ion selected from the group consisting of Cd, Cu, Fe, Pb, Ni and Zn.

The present invention further provides a method of detecting trace metal ions in water and effluent comprising contacting the water or effluent with the inventive micro-sensor apparatus, applying a voltage selected for the trace metal ion to be detected, measuring the current output of the micro-sensor apparatus, determining if the current output indicates the presence of any of the trace metal ions, and generating a signal. This signal can then be used to activate a display device, a recording means, an alarm device, and/or a compensating means.

The present invention optionally provides a plating means for removing and recovering trace metals from water and effluent.

It has now been found that the presence and concentration of a plurality of trace metal ions in water and effluent samples can be detected and quantified using an electrochemical micro-sensor comprising a substrate supporting an arrangement electrodes comprising at least one of a first type of working electrode; at least one of a second type of working electrode; a reference electrode; and a counter electrode. Each trace metal ion present will begin to react at the working electrodes, and become reduced at a characteristic applied voltage. By measuring the current produced when that characteristic voltage is applied, it is possible to quantify the concentration of that trace metal in the water or effluent sample. There exists a linear relationship between the current output and the concentration of the trace metal ion because, as the concentration increases, the amount of electrons transferred increases as well, contributing to a higher current output. This linear relationship allows the electrochemical micro-sensor apparatus of the present invention to detect and quantify the trace metal ion of interest. Novel electrochemical micro-sensors designed to operate on this basis to detect and quantify cadmium, copper, iron, lead, nickel, and zinc ions, were tested, and the results are reported herein.

### BRIEF DESCRIPTION OF THE DRAWINGS

FIG. 1 is a schematic illustration of the designs of sensor examples A-D.

FIG. 2 is a schematic illustration of the design of sensor example D.

FIG. 3 is a p lo t of the output current of sensor example D for cadmium detection over the voltage range of −1.2 to −0.4V.

### DETAILED DESCRIPTION OF THE INVENTION

The present invention is directed to a thick film electrochemical micro-sensor apparatus capable of in situ operation for detection and quantification of trace amounts of cadmium, copper, iron, lead, nickel, and zinc ions in water, effluent streams, and the like. More specifically, the present invention is directed to the fabrication and use of a chip-like thick film electrochemical micro-sensor apparatus. Since its invention, the microchip has been utilized for a variety of different problems. Technically a microchip does not have to be microscopic, but it should be of a reduced size. The present invention relates to microchip-like sensors that are not microscopic. The overall size of the micro-sensor device can vary greatly, dependent only on economic efficiency and user preference.

The micro-sensor device of the present invention is an electrochemical system in which a reversible redox reaction takes place. Electrochemical methods of analysis include all methods of analysis that measure current, potential and resistance, and relate them to analyte concentration. Voltammetric techniques have been classified as dynamic electrochemical techniques. In their operation the potential is controlled and the current is monitored. Voltammetric techniques are based on the measurement of current as a function of potential. The current is produced at an electrode surface following the oxidation or reduction of the analyte at a characteristic potential. Oxidation or reduction at the electrode surface is essentially electron-transfer (or charge transfer). In any voltammetric technique it is the charge transfer that is being measured. The current is measured in amperes, i.e. the rate of flow of charge. Voltammetric measurements are therefore measurements of the rate of reaction. The electrochemical reaction at the electrode surface is driven by the application of a potential to that electrode. The applied potential is the excitation signal and the measured current is the resulting signal. The potential at which the reaction occurs is characteristic of the analyte, the amount of current that is measured is related to concentration.

The electrochemical micro-sensor of the presence invention comprises a substrate on which are arranged a minimum of four electrodes, including at least two different types of working electrodes, and at least one each of a counter electrode and reference electrode. The electrodes are connected to a potentiostat, which applies the potential and measures the resulting current. The sensor may optionally further include a temperature detector and a pH detector. This sensor is portable and relatively small, and is able to be used in situ to detect and quantify amounts of trace metal ions in water, effluent streams, and the like.

The sensor is preferably made using a thick film technique, especially by deposition of multiple electrodes on a substrate. Electrochemical sensors and thick film techniques for their fabrication are discussed in U.S. Pat. No. 4,571,292 to C. C. Liu et al, U.S. Pat. No. 4,655,880 to C. C. Liu, and co-pending application U.S. Ser. No. 09/466,865, which patents and application are incorporated by reference as if fully written out below.

The substrate may be formed of plastic, glass, ceramic, alumina, quartz, or any other material that preferably is inert relative to the material of which the electrodes are formed and the material into which the sensor is intended to be placed for use. Preferably the substrate is an alumina ceramic material. Other suitable ceramics include aluminum nitride, beryllia, silicon carbide, silicon nitride, and the like.

The multiple electrodes include at least one of a first type of working electrode, at least one of a second type of working electrode, a reference electrode and a counter electrode. The potential is alternatingly applied to the working electrodes. These electrodes are the site of the redox reaction, and are where the charge transfer occurs. The function of the counter electrode is to complete the circuit, allowing charge to flow through the cell. The first type of working electrode and the counter electrode are preferably formed of the same material, although this is not a requirement. The material comprising the working electrodes and the counter electrode is preferably inert relative to the substrate and the electrolyte and will not irreversibly react with the trace metal target species. However, the working, or indicator electrodes are advantageously sensitive to at least one of the soluble trace metal target species, Cd, Cu, Fe, Pb, Ni and Zn.

Examples of materials suitable for the first type of working electrode include, but are not limited to, gold, platinum, palladium, silver, and carbon. Preferred materials are platinum or gold. Platinum, for example, is applied to the substrate in the form of a platinum ink, which is commercially available, or can be made using finely dispersed metal particles, solvent, and a binder. The ideal characteristics of an indicator electrode are a wide potential range, low resistance, and a reproducible surface. The potential window of an electrode depends on the electrode material and composition of the electrolyte.

Examples of materials suitable for the counter electrode include, but are not limited to, gold, platinum, palladium, silver, and carbon. Preferred materials are platinum or gold. The counter electrode is applied to the substrate in the same manner as the first type of working electrode, described above.

Preferably, the second type of working electrode comprises carbon. In one embodiment, both the first type of working electrode and the second type of working electrode comprise carbon. In this embodiment, appropriate voltages are applied to each working electrode to maximize current output while not evolving hydrogen.

Specific examples of suitable materials which comprise the reference electrode are silver-silver chloride and mercury-mercuric chloride (Calomel). Silver-silver chloride is preferred. The silver is applied to the substrate in the form of a silver ink, which is commercially available, or can be made using finely dispersed metal particles, solvent, and a binder. As described in further detail herein, the silver is exposed to hydrogen chloride solution to produce the silver-silver chloride electrode electrochemically.

The micro-sensor apparatus of the present invention may optionally further include a temperature detector, which preferably comprises platinum or platinum alloys. The temperature detector can be printed onto the opposite side of the ceramic substrate from the electrodes, in the form of a platinum ink, as described above.

The micro-sensor apparatus of the present invention may additionally include a pH detector, which preferably comprises palladium. The pH detector can also be printed onto the opposite side of the ceramic substrate from the electrodes, in the form of a palladium precursor ink, which is commercially available, or can be made using finely dispersed metal particles, solvent, and a binder.

The electrodes of the sensor apparatus of the present invention must include a connect portion and a sensing portion. The sensing portion of the electrode is exposed to the environment, and is in contact with the electrolyte and the target species. The sensing portion functions to detect the target species. The connect portion of the electrode connects the electrode to an electrical circuit, and is protected from the environment by an insulator. The insulator used to protect the connect portion of the electrodes of the present invention is preferably glass, and is applied in the form of an insulating ink. In a preferred embodiment, wires are soldered to the connect portion of the electrodes such as by using indium solder. The wires and the solder are then covered with a silicone paste.

The arrangement of the electrodes on the substrate is important. The counter and reference electrodes are placed close to the working electrodes. The shapes of the electrodes are important, as is their size and or any modification to their surfaces. It will be appreciated that the size of the sensor apparatus is not critical, and may be varied as practicable, so long as the arrangement and relative sizes of the electrodes remain substantially the same.

According to the invention, sensor designs were drawn on AUTO-CAD™, a computer drafting program. Then, through a thick film process, which is similar to the silk screening process, silver, platinum, palladium, carbon, and insulating precursor inks were printed onto alumina ceramic substrates to form the electrodes, the temperature detector, and the pH detector. The silver was treated with chloride to form silver-silver chloride, the material used for the reference electrode. Platinum was used for the temperature detector, the counter electrode, and the first type of working electrode. Palladium was used for the pH detector. The carbon precursor ink was used to form the second type of working electrode. The micro-sensors were heated to solidify the components, the wires were soldered to the contacts, and silicone paste was applied and cured. Finally, the sensors were tested by exposure to trace metal ion concentrations of from about 0 to about 500 parts per million (ppm).

To use the micro-sensor device, a voltage must be applied and the current measured. The voltage used depends on the target species and the type of electrodes used. The corresponding current produced is used to quantify the concentration of the target species.

### Specific Embodiments of the Inventions

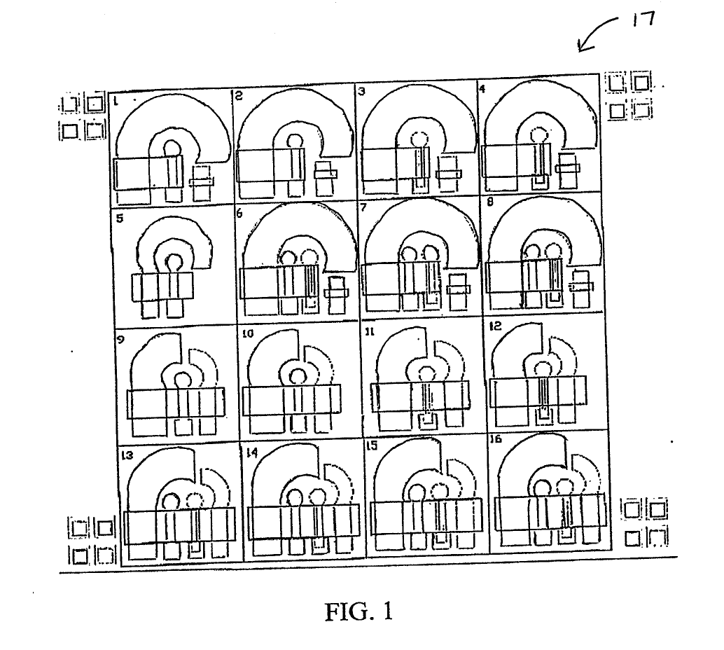

FIG. 1 shows four of the sensor designs tested. The number in the upper left corner of each section is used to identify each individual chip. Chips 1 through 16 make up multi-chip device 17. Chips 1 through 4 are replicates of sensor example A. Chips 6 through 8 are replicates of sensor example B. Chips 9 through 12 are replicates of sensor example C. Chips 13 through 16 are replicates of sensor example D.

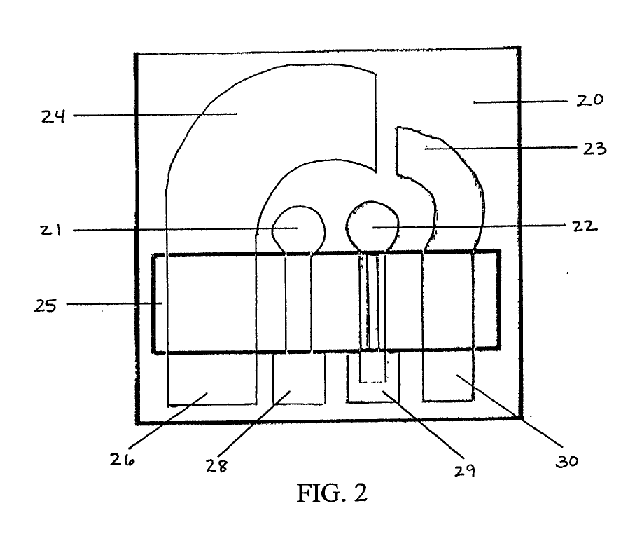

One preferred sensor design, sensor example D, is shown in enlarged form in FIG. 2. This sensor demonstrated superior performance for the detection and quantification of each trace metal ion tested, as discussed below. Four electrodes are arranged on a substrate 20. The shape of the sensing portion of the electrodes in sensor example D in the plan view is such that the edges are substantially rounded, that is, sharp edges are avoided. The working electrodes 21, 22 are placed in between the reference electrode 23 and the counter electrode 24. The counter electrode has edges adjacent to both working electrodes. The surface area of the counter electrode is substantially greater than the surface areas of the working electrodes. The reference electrode is approximately equal in size to the working electrode. Insulation 25 covers the connect portion of the electrodes, and separates the sensing portion of the electrodes from the contacts 26, 28, 29, 30 to which wires are soldered.

In comparative sensor design example A, shown in FIG. 1 as chips 1 through 4, one working electrode is placed between an enlarged counter electrode and rectangularly shaped reference electrode. Comparative sensor design example B, shown in FIG. 1 as chips 6 through 8, is similar, except that it contains two working electrodes. The counter electrode in comparative sensor design example C, shown in FIG. 1 as chips 9 through 12, has less surface area, while the surface area of the reference electrode has increased. One working electrode is arranged between the counter electrode and the reference electrode.

### Experimental Procedures

The thick film electrochemical micro-sensors according to the invention were fabricated according to the procedure below.

In the fabrication process of sensor examples A-D, an AutoCAD program was used to design the sensor, and a high resolution laser printer was used to print the design on UV-transparent plastic film. The plastic film was then used to expose a UV-sensitive emulsion that was then adhered to a stainless steel screen. The film was then developed in a hydrogen peroxide solution, and washed using hot water. The design was pressed into a stainless steel screen and dried in air. The mylar backing of the emulsion was removed. A layer of Majiastar Block Out® material was used to cover all areas of the screen where ink was not to pass through. These mesh screens were the templates for the thick film process. They were then loaded into an MPM TF-100 screen printer to “silk-screen” the silver and platinum precursor inks individually onto the alumina ceramic substrates. After the thick film process, the ceramic substrates were placed into a drying oven and heated at 100° C. to remove the solvent. Next, the substrates were fired in a furnace at 850° C. to solidify the inks onto the substrates. The sensors then had a carbon ink layer applied to form the second type of working electrode, and were again heated at 100° C. An insulating precursor ink was applied over a portion of the sensor, and cured at 100° C. Afterwards, the substrates were diced using a diamond saw into individual devices. The resulting sensor devices were approximately 2 centimeters wide by 2 centimeters long. The wires were soldered to the connect portion of the sensor device using a soldering iron, flux, and indium solder. The connect portion of the sensor device was then covered with insulation, such as silicone. The silver electrode of the sensor device was cleaned using a mechanical pencil eraser. 0.1M hydrochloric acid solution was placed in a beaker. A platinum screen was connected to the negative side of a potentiostat. The wire attached to the silver electrode was connected to the positive side of the potentiostat. Both the platinum screen and the sensor device was placed into the beaker of 0.1M hydrochloric acid without allowing them to touch one another. A voltage of 1V was applied. The silver surface was first cleaned by turning the power up for 5 seconds and down for seconds three times each. Then the chloride was allowed to react with the silver to form silver-silver-chloride by leaving the power on for 1 to 3 minutes, until a dark color is acheived. The sensor was rinsed using warm water and de-ionized water, and placed on paper towels to dry.

Test solutions were prepared to contain from about 0 to about 500 parts per million of a target species. The target species were the ions of the metals cadmium, copper, iron, lead, nickel, and zinc. These concentration levels were chosen to be high enough to generate accurate and reproducible results when used to calibrate the electrochemical micro-sensor devices, while also representing the typically low concentrations to be found in water and effluent samples. The test solutions also contained about 0.1M of an electrolyte. Although it is envisioned that the addition of electrolyte will not be needed for analysis of effluent liquids, the test solutions were prepared with deionized water, and therefore addition of electrolyte was necessary to simulate real-life samples. Electrolyte solutions are a combination of solvent and supporting electrolyte. The choice of the electrolyte solution depends on the application. In general, the solution must be conducting, chemically and electrochemically inert. In other words, the electrolyte solution facilitates passage of current, and over as wide an applied potential range as possible, it should not contribute to any chemical reactions and must not undergo any electrochemical reaction within the applied potential range. In environmental applications, the most common electrolyte solution is water with an added salt of buffer. Specific examples of suitable supporting electrolytes include, but are not limited to sulfuric acid, potassium nitrate, sodium sulfate, and sodium chloride. In some studies, usually organic electrode processes, the system may be non-aqueous. Acetonitrile or dimethyl sulphoxide are common solvents. Supporting electrolytes added include, but are not limited to tetrabutylammonium hexafluorophosphate or tetrabutylammonium tetra-fluorophosphate (TBAPF4). While standard solutions and some relatively pure water samples may require the addition of electrolyte, many types of water and effluent will not. The naturally occurring counterions to the trace metals present in the water samples will serve as an electrolyte, permitting the inventive sensor to measure trace metal ion concentrations in situ in streams, rivers, lakes, effluent, and the like.

The thick film sensors of the present invention operate based on oxidation and reduction reactions. The specific reduction and oxidation reactions which occur will depend upon the oxidation state of the target species. Copper can be reduced in two ways. Examples of reaction schemes are shown below.

### Scheme 1

Zn²⁺+2e⁻→Zn (reduction)

Zn→Zn²⁺+2e⁻(oxidation)

### Scheme 2

Fe³⁺+e⁻→Fe²⁺(reduction)

Fe²⁺→Fe³⁺+e⁻(oxidation)

### Scheme 3

Cu²⁺+2e⁻Cu (reduction)

Cu→Cu²⁺+2e⁻(oxidation)

### or

Cu²⁺+e^{-→Cu}¹⁺+→Cu (reduction)

The micro-sensor device was connected to a CH/660A Electrochemical Workstation and placed into a beaker containing a test solution. Initial testing was done using the technique of cyclic voltammetry. Cyclic voltammetry is a steady increase or decrease of potential with time. The applied potential sweeps backwards and forwards between two limits, the starting potential and the switching potential, and the current output is measured. The wave form is in the shape of a triangular linear-scan. A cyclic voltammogram can determine in what potential range to look for the reduction of the target species. The peak position gives qualitative information and is dependent on the identity of the target species. The peak to peak separation, for a reversible redox reaction, gives the number of electrons transferred. At a constant scan rate, the peak height gives quantitative information, relating the amount of current to the concentration of the target species.

Another useful technique is sweep-step voltammetry. This technique, although very sensitive, is more time-consuming.

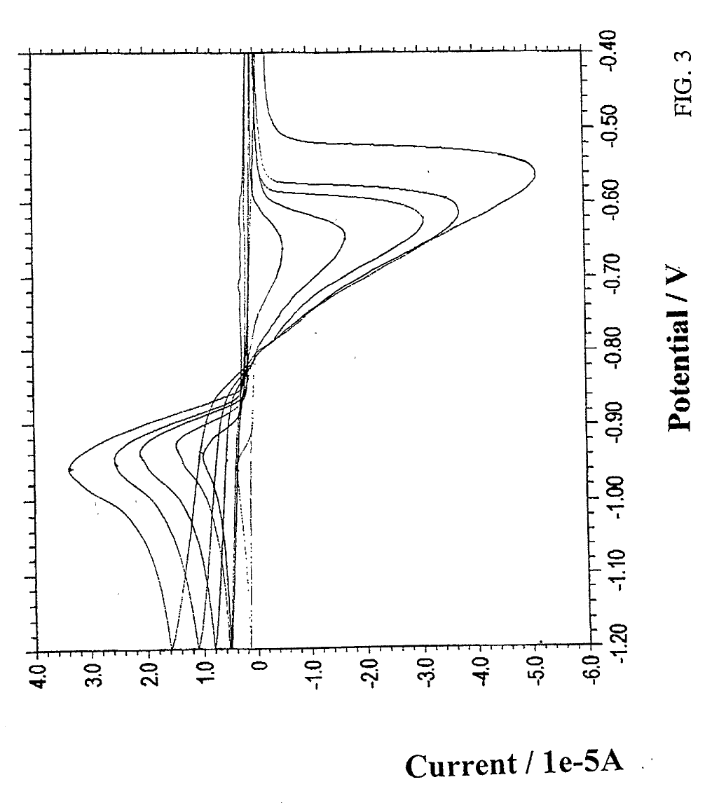

The range of voltage used was initially −0.1 to 0.1 V. A test solution containing a suitable concentration of the desired target species was used. If the desired target species was copper or iron ions, the voltage was applied to the first type of working electrode, in this case the platinum type. If the desired target species was cadmium, nickel, lead, or zinc ions, the voltage was applied to the second type of working electrode, which is the carbon type. If no peak was found, the range was increased in both directions by 0.1 V until a peak was found. Once the peak for that target species was established, solutions containing a range of concentrations of the target species were tested and a graph of output current versus target species concentration was generated. A plot of output current versus applied voltage at different concentration levels of cadmium using sensor example D is shown in FIG. 3.

Zinc ions cannot be effectively detected or quantified using a platinum working electrode. Preferential reaction of hydrogen ions interferes with the analysis. Therefore, a working electrode must be selected which has a surface on which no interfering competitive reaction can take place. Carbon provides such a surface. Cadmium, nickel and lead ions are also preferably detected and quantified using a carbon working electrode. This interference effect is therefore overcome by employing two types of working electrodes on a single micro-sensor. For example, the first type of working electrode can comprise platinum, and can be used to detect and quantify copper and iron ions. The second type of working electrode can comprise carbon, and can be used to detect and quantify cadmium, nickel, lead, and zinc ions. Although these two types of working electrodes could be placed on separate micro-sensors and then used in a dual sensor mode, this approach would be less efficient and more costly, requiring two reference electrodes, counter electrodes, temperature detectors, and pH detectors, two sets of wiring, and the like.

The voltage ranges and type of electrode used are shown in Table 4. Within these voltage ranges were the positions of the peak current for oxidation and reduction of the target species. Although the absolute peak positions will vary somewhat based upon the electrode material and configuration, the approximate voltage ranges and the relative order in which the peaks occur will remain the same.

TABLE 4

| Metal | Type of Electrode | Ox. Voltage | Red. Voltage |
|---|---|---|---|
| Cadmium | Carbon | −0.8 to −0.6 | −0.9 to −1.0 |
| Copper | Platinum | 0.0 to 0.1 | −0.2 to −0.4 |
| Iron | Platinum | | −0.6 to −0.8 |
| Nickel | Carbon | | −1.2 to −1.4 |
| Lead | Carbon | −0.6 to −0.2 | −0.8 to −1.0 |
| Zinc | Carbon | −0.8 to −0.4 | −1.4 to −1.6 |

Various sensor configurations were prepared and tested according to the present invention. Lines were generated for peak output current versus metal concentration, and correlation coefficients were calculated. Correlation coefficients (R) for data obtained using sensor examples A-D are summarized in Table 5.

TABLE 5

| | Sensor A | Sensor B | Sensor C | Sensor D |
|---|---|---|---|---|
| Metal | R-value | R-value | R-value | R-value |
| Cd (red) | 0.991 | 0.994 | 0.989 | 0.994 |
| Cd (ox) | 0.945 | 0.986 | 0.988 | 0.984 |
| Cu (red) | 0.917 | 0.764 | 0.883 | 0.934 |
| Cu (ox) | 0.772 | 0.453 | 0.899 | 0.983 |
| Fe (red) | 0.003 | 0.595 | 0.857 | 0.999 |
| Ni (red) | 0.405 | 0.959 | 0.956 | 0.984 |
| Pb (red) | 0.833 | 0.995 | 0.974 | 0.971 |
| Pb (ox) | 0.805 | 0.917 | 0.940 | 0.972 |
| Zn (red) | 0.227 | 0.776 | 0.731 | 0.967 |
| Zn (ox) | 0.933 | 0.789 | 0.995 | 0.981 |

As can be seen from this data, sensor example D gives the best correlation between output current and target species concentration. Equations describing the correlation between output current and target species concentration for sensor example D are shown in Table 6. The concentration of the target species is measured in parts per million (ppm).

TABLE 6
Current vs. Concentration Lines for the Six Metals on Sensor D

| Metal | Reduction Line | Oxidation Line |
|---|---|---|
| Copper | Current = | Current = |
| | 8E^{-7(concentration)} + 2E⁻⁵ | −5E^{-6(concentration)} + 2E⁻⁶ |
| Iron | Current = | — |
| | 6E^{-5(concentration)} − 1E⁻⁵ | — |
| Cadmium | Current = | Current = |
| | 6E^{-5(concentration)} − 2E⁻⁵ | −1E^{-4(concentration)} + 1E⁻⁴ |
| Lead | Current = | Current = |
| | 8E^{-6(concentration)} − 6E⁻⁶ | −7E^{-6(concentration)} + 1E⁻⁵ |
| Nickel | Current = | — |
| | 3E^{-6(concentration)} + 4E⁻⁶ | |
| Zinc | Current = | Current = |
| | 5E^{-7(concentration)} + 4E⁻⁶ | −3E^{-7(concentration)} − 4E⁻⁶ |

Potential interference between metal ions was investigated, and the influence of one metal ion upon another was mathematically determined. From these influences, the optimum order of evaluation for test solutions containing mixtures of metals was determined. The order of evaluation refers to the order in which the computer reads current from the test run. For example, if zinc is present in the test solution, it can interfere with the cadmium analysis. However, once the presence of an interference is determined, the computer can determine the zinc concentration first, then determine the cadmium concentration, making an adjustment for the zinc interference. The preferable order of evaluation for each electrode is listed in Table 7.

TABLE 7

| Order | Platinum Electrode | Carbon Electrode |
|---|---|---|
| 1 | Copper | Nickel |
| 2 | Iron | Zinc |
| 3 | | Lead |
| 4 | | Cadmium |

Test solutions containing 100 ppm of an interfering metal and various concentrations of the metal of interest were prepared and tested. Equations were determined which adjust for the observed interferences. These equations are shown in Tables 8 and 9. The concentration term in these equations refers to the concentration of the metal of interest in parts per million.

TABLE 8
Interference on the Platinum Working Electrode

| Metal of | Interfering Metal | |
|---|---|---|
| Interest | Copper | Iron |
| Copper | | Current = −9E^{-7(concentration)} + |
| | | 8E⁻⁷⁰⁰ (minimal) |
| Iron | Current = −4E^{-6(concentration)} + | |
| | 6E⁻⁶ −6E⁻⁵⁰⁰ (medium) | |

TABLE 9
Interference on the Carbon Working Electrode

| Metal | | | | |
|---|---|---|---|---|
| of | Interfering Metal | | | |
| Interest | Cadmium | Lead | Nickel | Zinc |
| Cad- | | Current = | Current = | Current = |
| mium | | 4E^{-6(conc)} + | 7E^{-6(conc)} + | 1E^{-7(conc)} + |
| | | 5E⁻⁵ −6E⁻⁵⁰⁰ | 4E⁻⁵ −6E⁻⁵⁰⁰ | 7E⁻⁶ −6E⁻⁵⁰⁰ |
| | | (significant) | (significant) | (very |
| | | | | significant) |
| Lead | Current = | | Current = | Current = |
| | 7E^{-7(conc)} + | | 2E^{-7(conc)} + | −2E^{-6(conc)} + |
| | 2.6E⁻⁵ −8E⁻⁶⁰⁰ | | 1.6E⁻⁶ −8E⁻⁶⁰⁰ | 1.6E⁻⁵ −8E⁻⁶⁰⁰ |
| | (minimal) | | (very minimal) | (medium) |
| Nickel | Current = | Current = | | Current = |
| | 8E^{-7(conc)} + | 1E^{-6(conc)} + | | 3E^{-6(conc)} + |
| | 2.4E⁻⁶ −3E⁻⁶⁰⁰ | 6E⁻⁶ −3E⁻⁶⁰⁰ | | 1.6E⁻⁵ −3E⁻⁶⁰⁰ |
| | (minimal) | (minimal) | | (minimal) |
| Zinc | Current = | Current = | Current = | |
| | ^{3E-6(conc)} + | 6E^{-6(conc)} + | 2E^{-5(conc)} + | |
| | 6E⁻⁶ −5E⁻⁷⁰⁰ | 3E⁻⁶ −5E⁻⁷⁰⁰ | 2.6E⁻⁵ −5E⁻⁷⁰⁰ | |
| | (minimal) | (minimal) | (very | |
| | | | significant) | |

Temperature also plays a large role in the current versus concentration relationship. Since ions move more quickly at higher temperatures, a higher current per given amount of concentration will be achieved at higher temperatures. However, the correlation between output current and temperature can be determined through testing. Accordingly, the electrochemical micro-sensor apparatus of the present invention may further comprise a temperature detector such as thermistor or temperature-detecting electrode. Such a temperature detector could be calibrated and used to enable the computer to make adjustments in the concentration calculations to take temperature variations into account. Thus, the micro-sensor apparatus will be able to accurately determine the concentration of the metals over a wide range of temperature.

Equations describing the correlation between temperature of the solution and output current for solutions containing 100 ppm of the metal of interest are given in Table 10.

TABLE 10
Temperature vs. Current Relationships for each Metal

| | |
|---|---|
| Metal | Regression line for Temperature vs. Current |
| Cadmium | Current = 3E^{-6(temperature)} + 4E⁻⁵ − 6E⁻⁵⁰⁰ |
| Copper | Current = 7E^{-6(temperature)} − 1E⁻⁵ − 8E⁻¹⁴⁰⁰ |
| Iron | Current = 5E^{-6(temperature)} + 4E⁻⁵ − 6E⁻⁵⁰⁰ |
| Lead | Current = 6E^{-6(temperature)} + 6.3E⁻⁶ − 8E⁻⁶⁰⁰ |
| Nickel | Current = 2E^{-6(temperature)} + 6E⁻⁶ − 3E⁻⁶⁰⁰ |
| Zinc | Current = 2E^{-6(temperature)} + 6E⁻⁶ − 5E⁻⁷⁰⁰ |

Advantageously, by eliminating the variables caused by inter-metal interferences and temperature, the electrochemical micro-sensor of the present invention can accurately and effectively measure the concentration of cadmium, copper, iron, lead, nickel and zinc in various solutions.

In one preferred embodiment, the counter and reference electrodes are preferably placed close to the working electrode. The shapes of the electrodes, their size, and any modification to their surfaces can impact their performance. It is preferable that the shape of the electrodes be rounded, without sharp corners. In one preferred embodiment, sensor example D, shown in FIG. 2, the electrodes are substantially round. The counter electrode is substantially larger than the working electrode, allowing greater surface area for reaction. Previous work has indicated that the ratio of the surface area of the counter electrode to the surface area of the working electrode should preferably be in the range of about 1:1 to about 20:1, and more preferably, from about 5:1 to about 20:1. The reference electrode should be about the same size as the working electrode. Another factor in the design of the micro-sensor and the configuration of the electrodes is that it is preferable to have the working electrodes in the middle, close to both the reference electrode and the counter electrode. Sensor designs having the reference electrode between the working electrodes and the counter electrode will not operate as efficiently. Yet another sensor configuration requirement is that the locations on the connect portion of the sensor where the wires are soldered must not be so close together that there is any possibility of short-circuits.

In actual operation, analysis of a sample may be performed on-site, by simply contacting the inventive micro-sensor with the liquid to be tested, measuring the current output of the sensor, determining if the current output indicates the presence of any of the trace metal ions, and generating a signal. It will be understood that a microprocessor may be used to facilitate measurement and analysis.

In a preferred embodiment, the metals are analyzed in a preferred sequential order, described hereinabove, and the microprocessor adjusts for interfering species. Preferably, the temperature of the liquid solution is also measured, and the microprocessor compensates for the temperature effect on the current output.

The signal generated by the inventive micro-sensor can then be used to activate a display device, a recording means, an alarm device, and/or a compensating means. The micro-sensor apparatus may be further adapted to perform an actuating function, such as to trigger a plating means known in the art to plate out the metals that are detected.

In a preferred embodiment, an optional plating system comprises the electrochemical micro-sensor apparatus of the present invention, having switched polarities with respect to the sensing micro-sensor apparatus. The time required to plate out the metal of interest from solution will be largely determined by the following equation: Coulombs=(Current)(time in seconds), where the amount of energy required to plate out 1 mole of a single valence ion is 96,500 coulombs. It will be understood by those skilled in the art of plating that various other factors, such as contacting efficiency of the plating system, will also affect the time required.

It is therefore demonstrated that the electrochemical micro-sensor apparatus of the present invention can be used to detect trace metal ions cheaply and quite effectively in various locations, including waste water effluent, streams, lakes, ponds, and the like. When a trace metal ion is detected, the sensor can generate a signal that is sent to an indicator, such as an alarm, or visual display, or to a recorder, making it possible to study process trends and track emissions over a period of time. The sensor can generate a signal that is amplified if necessary, and that actuates a plating system only when a pre-determined level of a trace metal ion is detected, allowing efficient removal of the trace metal. In one embodiment, the plating system plates out each trace metal separately, and is, in fact, a recovery means for recycling the metals.

It should now be apparent that various embodiments of the present invention accomplish the object of this invention. It should be appreciated that the present invention is not limited to the specific embodiments described above, but includes variations, modifications, and equivalent embodiments defined by the following claims.

We claim:

1. An electrochemical micro-sensor apparatus for detecting or quantifying trace metal ions comprising a substrate supporting an arrangement of electrodes comprising:
(a) at least one of a first type of working electrode;
(b) at least one of a second type of working electrode;
(c) a reference electrode; and
(d) a counter electrode;
wherein the electrodes are applied to the substrate using a thick film technique, and wherein each working electrode is sensitive to at least one metal ion selected from the group consisting of Cd, Cu, Fe, Pb, Ni and Zn.

2. The electrochemical micro-sensor apparatus of claim 1, wherein the substrate is an insulator selected from the group consisting of plastic, glass, ceramic, quartz, and mixtures thereof.

3. The electrochemical micro-sensor apparatus of claim 1, wherein the substrate is alumina.

4. The electrochemical micro-sensor apparatus of claim 1, wherein the first type of working electrode and counter electrode are each independently selected from the group consisting of gold, platinum, palladium, silver, carbon, and mixtures thereof.

5. The electrochemical micro-sensor apparatus of claim 1, wherein the second type of working electrode comprises carbon.

6. The electrochemical micro-sensor apparatus of claim 1, wherein the reference electrode comprises one of silver-silver chloride and mercury-mercuric chloride.

7. The electrochemical micro-sensor apparatus of claim 1, wherein each electrode has a connect portion and a sensing portion, wherein the connect portion connects the electrode to an electrical circuit and is protected from the environment by an insulator, and wherein the sensing portion is exposed to the environment.

8. The electrochemical micro-sensor apparatus of claim 1, wherein the thick film technique comprises:
providing a template containing the pattern for the arrangement of the electrodes;
contacting the substrate with the template;
applying at least one electrode precursor ink, and insulator precursor ink onto the template/substrate according to the template pattern to form a sensor configuration;
drying the sensor configuration;
firing the sensor configuration to solidify the precursor inks;
applying a carbon electrode precursor ink onto the template/substrate according to the template pattern to add an additional electrode to the sensor configuration; and
drying the sensor configuration to form the sensor apparatus.

9. The electrochemical micro-sensor apparatus of claim 1, further comprising a temperature detector.

10. The electrochemical micro-sensor apparatus of claim 9, wherein the temperature detector comprises platinum or a platinum alloy.

11. The electrochemical micro-sensor apparatus of claim 1, further comprising a pH detector, optionally wherein the pH detector comprises palladium.

12. The electrochemical micro-sensor apparatus of claim 7, wherein the sensing portions of the working electrodes are disposed generally between the reference electrode and the counter electrode.

13. The electrochemical micro-sensor apparatus of claim 1, wherein the working electrodes are rounded in shape.

14. A method of detecting and quantifying trace metal ions in water or effluent comprising
contacting the water or effluent with the micro-sensor apparatus of claim 1;
applying a voltage selected for the trace metal ion to be detected;
measuring the current output of the micro-sensor apparatus;
determining if the current output indicates the presence of the trace metal ion; and
generating a signal.

15. The method of claim 14, further comprising the step of adjusting for at least one of temperature effects and interferencing species.

16. The method of claim 14, further comprising transmitting the signal to at least one device selected from the group consisting of display devices, recording means, alarm devices, and compensating means.

17. The method of claim 16, wherein the compensating means comprises plating means.

18. The method of claim 17, wherein the plating means comprises the electrochemical micro-sensor apparatus of claim 1 having switched polarities with respect to the sensing micro-sensor apparatus.

19. A method of removing and recovering trace metals from water or effluent comprising contacting the water or effluent with the micro-sensor apparatus of claim 1; applying a voltage selected for the trace metal to be detected; measuring the current output of the micro-sensor apparatus; determining if the current output indicates the presence of the trace metal; generating a signal; transmitting the signal to actuate a plating means; and plating out the trace metal.

20. The electrochemical micro-sensor apparatus of claim 4, wherein the first type of working electrode is used to detect and quantify copper and iron ions, and the second type of working electrode is used to detect and quantify cadmium, nickel, lead, and zinc ions.
